(19) United States
(12) Patent Application Publication
(10) Pub. No.: US 2013/0244876 A1
(43) Pub. Date: Sep. 19, 2013

(54) Synergistic compositions comprising ethephon and saflufenacil or cyclanilide and saflufenacil

(71) Applicants: Thorsten JABS, Hassloch (DE); Alexandre FRATESCHI, Santana de Parnaiba (BR); Paulo Cesar QUEIROZ, Valinhos (BR); Guy Mitsuyuki TSUMANUMA, Sao Paulo (BR); Marco-Antonio TAVARES-RODRIGUES, Mannheim (DE); Brady Scott ASHER, Pittsboro, NC (US); John HARDEN, Raleigh, NC (US)

(72) Inventors: Thorsten JABS, Hassloch (DE); Alexandre FRATESCHI, Santana de Parnaiba (BR); Paulo Cesar QUEIROZ, Valinhos (BR); Guy Mitsuyuki TSUMANUMA, Sao Paulo (BR); Marco-Antonio TAVARES-RODRIGUES, Mannheim (DE); Brady Scott ASHER, Pittsboro, NC (US); John HARDEN, Raleigh, NC (US)

(21) Appl. No.: 13/796,338

(22) Filed: Mar. 12, 2013

Related U.S. Application Data
(60) Provisional application No. 61/610,549, filed on Mar. 14, 2012.
(60) Provisional application No. 61/610,555, filed on Mar. 14, 2012.

(51) Int. Cl. A01N 57/20; A01N 37/22; A01N 43/54

(52) U.S. Cl. CPC A01N 57/20; A01N 43/54; A01N 37/22
USPC 504/128; 504/131

(57) ABSTRACT

The present invention relates to mixtures comprising, as active components ethephon and saflufenacil or cyclanilide and saflufenacil and to a method for defoliating, desiccating or ripening cultivated plants using such mixtures and to the use of ethephon and saflufenacil or of cyclanilide and saflufenacil for preparing such mixtures, and to compositions comprising these mixtures.

### CROSS REFERENCE TO RELATED APPLICATIONS

This application claims the benefit of U.S. Application No. 61/610,549, filed Mar. 14, 2012, and U.S. Application No. 61/610,555, filed Mar. 14, 2012, the entire contents of which are hereby incorporated herein by reference.

### DESCRIPTION

The present invention relates to mixtures comprising, as active components ethephon and saflufenacil or cyclanilide and saflufenacil.

Defoliants, desiccants and ripeners are classified as harvest aid chemicals because they are commonly used to facilitate mechanical harvesting of cultivated plants or improve the quality of the harvested crop. Desiccation, defoliation and/or ripening of cultivated plants (crops) is a standard pre-harvest practice in certain cultivated plants such as cotton, tobacco, potatoes, tomatoes, oil seed rape, rice, sunflowers, soybean, field peas, lentil, sugar cane, dry beans and faba bean to increase harvest efficiency and crop quality. Defoliants, desiccants, and growth regulators are chemicals used in agricultural production to accelerate the preparation of crops for mechanical harvest.

Defoliation resulting in removal of the foliage is mainly required in cotton and is a sensitive process. For a successful harvest, defoliation must be carefully timed and carried out. Defoliation may also help to increase harvest efficiency, reduce lodging, reduce trash and lint staining and reduce cotton seed moisture. Poor defoliation can lower harvest quality, while defoliating too early lowers yield. Defoliating too late increases the likelihood of harvest rot and damage or loss due to weathering.

Desiccation is the term used for a pre-harvest practice to rapidly kill vegetative growth or to promote uniform yellowing of the foliage of the respecitive crop plants e.g. in tobacco, potatoes, tomatoes, oil seed rape, rice, sunflowers, soybean, field peas, lentil, sugar cane and faba bean. This allows for rapid or more regular dry down and an earlier harvest. It can further help farmers plan their harvest operations, salvage crops which are ripening irregularly and produce harvest of increased quality, e.g. potato tuber quality.

Ripeners are used for example in sugar cane to increase the sugar content of the harvest. Ripeners hasten plant maturity and prolong the period of maximum stalk sucrose concentration. Ripeners typically inhibit apical meristem growth. Presumably, this allows energy ordinarily used for vegetative growth to be diverted to the manufacturing and storing of sucrose. A ripener can also extend the period of high sucrose in responsive varieties. As a result of leaf desiccation, an improved trash burn at harvest can be expected. Most of the enhanced sucrose content will be concentrated in the top of the treated cane stalk. Ripener application rates can lead to an earlier harvest (e.g., 3 weeks after application) than sugarcane treated without any ripener treatment. Glyphosate is known to act as ripener in sugar cane.

Saflufenacil (Kixor™) is a herbicide of the pyrimidinedione chemical class inhibiting protoporphyrtinogen IX oxidase activity for preplant burndown and selective preemergence dicot weed control in multiple crops, including corn (Grossmann et al. Weed Science, 58 (2010), 1-9). The use of herbicidal pyrimidinediones as desiccants and/or defoliants is generally mentioned in WO 2001/083459.

Ethephon is a plant growth regulator used as defoliant or desiccant e.g. in cotton and potatoes (Ethephon [281]—plant growth regulator—ethylene regulator. Electronic Pesticide Manual 11th ed. Version 1.1, British Crop Protection Council, GB, page 1-2, XP002168005; Ben-Tal Y, Acta Horticulturae (1987) Nr. 201, 117-123).

Cyclanilide is a plant growth regulator used as defoliant or desiccant e.g. in cotton and potatoes. Cyclanilide is known to be suitable for use with desiccants and defoliants such as thidiazuron or its mixture with diuron (U.S. Pat. No. 6,274,535 B1). Cyclanilide is also known to be suitable for a plant growth regulator composition in mixture with ethephon (WO 87/05781; commercially available product Finish®, Bayer Crop Science, Germany, containing ethephon 480 g/L+cyclanilide 60 g/L).

By combining active compounds having different mechanisms of action, it is possible to ensure successful defoliation in broad variety of crops under various conditions.

It is an object of the present invention to provide, with a view to effective defoliation or desiccation, at application rates which are as low as possible, compositions which, at a reduced total amount of active compounds applied, have improved defoliation and/or desiccation activity and/or less dependency of this activity on timing, in particular for cotton, tobacco, potatoes and tomatoes.

We have accordingly found that this object is achieved by the mixtures and compositions defined herein, comprising saflufenacil and ethephon or saflufenacil and cyclanilide.

Thus, the present invention relates to mixtures comprising, as active components
1) saflufenacil; and
2) ethephon or cyclanilide.

Preferably, the invention relates to mixtures comprising, as active components
1) saflufenacil and
2) ethephon in a synergistically effective amount.

According to one embodiment, component 2) is ethephon.

According to another embodiment, component 2) is cyclanilide.

The present invention also relates to mixtures comprising, as active components
1) saflufenacil; and
2) ethephon.

Preferably, the invention relates to mixtures comprising, as active components
1) saflufenacil and
2) ethephon in a synergistically effective amount.

The present invention also relates to mixtures comprising, as active components
1) saflufenacil; and
2) cyclanilide.

Preferably, the invention relates to mixtures comprising, as active components
1) saflufenacil and
2) cyclanilide in a synergistically effective amount.

Moreover, the invention relates also to a method for defoliating, desiccating or ripening cultivated plants using mixtures comprising saflufenacil and ethephon and to the use of the components 1) and 2) as defined herein for preparing such mixtures, and to compositions comprising these mixtures.

Moreover, we have found that simultaneous, that is joint or separate, application of saflufenacil and ethephon allows better defoliation of crop plants than is possible with the individual compounds alone (synergistic mixtures). Furthermore, synergistic effects in relation with the herbicidal and fungicidal action have been found with the inventive mixtures.

The invention also relates to a method for defoliating crop plants using mixtures comprising component 1) and component 2) as defined herein and to the use of saflufenacil and ethephon or of saflufenacil and cyclanilide for preparing such mixtures, and to compositions comprising these mixtures and seed comprising these mixtures or coated with this mixture.

The mixtures and compositions thereof according to the invention can, in the use form as defoliation agents, also be present together with other active substances, e. g. with herbicides, insecticides, growth regulators, fungicides or else with fertilizers, as pre-mix or, if appropriate, not until immeadiately prior to use (tank mix).

According to a further embodiment, the mixtures and compositions thereof consist of as active components saflufenacil and ethephon. This means that these mixtures may not contain a further active substance.

According to a further embodiment, the mixtures and compositions thereof consist of as active components saflufenacil and cyclanilide. This means that these mixtures may not contain a further active substance.

Mixing the active component 1) and component 2) or the compositions comprising them, respectively, in the use form as defoliation agents with other active substances suitable for defoliation of crop plants such as plant growth regulators results in many cases in an increase of the defoliating activity being obtained or in a prevention of poor defoliation under certain environmental conditions. Furthermore, in many cases, synergistic effects are obtained.

Preferably, such ternary mixtures wherein component 2) is ethephon comprise as active component 3) a further active compound, preferably in a synergistically effective amount. Another embodiment relates to mixtures wherein the component 3) is an active compound Ill selected from the class of bio regulators:

pyraclostrobin, abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole. More preferably, such ternary mixtures comprise besides saflufenacil and ethephon as active component 3) cyclanilide. More preferably, such ternary mixtures comprise besides saflufenacil and ethephon as active component 3) pyraclostrobin.

Preferably, ternary mixtures wherein component 2) is cyclanilide comprise as active component 3) a further active compound, preferably in a synergistically effective amount. Another embodiment relates to mixtures wherein the component 3) is an active compound III selected from the class of bio regulators:
pyraclostrobin, abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole.

More preferably, such ternary mixtures comprise as active component 3) ethephon. More preferably, such ternary mixtures comprise besides saflufenacil and cyclanilide as active component 3) pyraclostrobin.

Generally, mixtures of strobilurin fungicides such as pyraclostrobin with plant growth regulators have been mentioned in WO 2007/001919. A mixture of pyraclostrobin with ethephon and saflufenacil is not disclosed therein. Likewise, a mixture of pyraclostrobin with ethephon or cyclanilide is not disclosed therein. The use of these mixtures as harvest aid such as cotton defoliant, desiccant or ripener is also not mentioned. The present invention relates also to a mixture comprising as active components ethephon and pyraclostrobin or to a mixture comprising as active components cyclanilide and pyraclostrobin and to a method for defoliating, desiccating or ripening cultivated plants using such mixtures and to the use of ethephon and pyraclostrobin or of cyclanilide and pyraclostrobin for preparing such mixtures, and to compositions and seed comprising these mixtures. According to a further embodiment, the mixtures and compositions thereof consist of as active components pyraclostrobin and ethephon. This means that these mixtures may not contain a further active substance. Likewise, according to a further embodiment, the mixtures and compositions thereof consist of as active components pyraclostrobin and cyclanilide.

Even more preferably, quarternary mixtures comprise as active components besides saflufenacil, ethephon and pyraclostrobin as active component 4) cyclanilide.

Even more preferably, quarternary mixtures comprise as active components besides saflufenacil, ethephon and pyraclostrobin as active component 4) cyclanilide.

The mixtures and compositions according to the invention are particularly important in the defoliation, desiccation and/or ripening of various cultivated plants, such as cotton, tobacco, potatoes, tomatoes, oil seed rape, rice, sunflowers, soybean, dry bean, faba bean, field peas, lentil and sugar cane, preferably in cotton, sugar cane, soybean and potato, in particular cotton. The mixtures and compositions according to the invention can be used as harvest aid chemicals to function as defoliants, desiccants or ripeners.

According to one embodiment, the mixtures and compositions according to the invention can be used as defoliants in cotton.

According to another embodiment, the mixtures and compositions according to the invention can be used as desiccants in tobacco, potato, tomato, oil seed rape, rice, sunflowers, soybean, dry bean, faba bean, field peas, lentil and sugar cane, more preferably in potato, soybean and sugar cane.

According to a further embodiment, the mixtures and compositions according to the invention can be used as ripener in sugar cane.

The term “cultivated plants” is to be understood as including plants which have been modified by breeding, mutagenesis or genetic engineering including but not limiting to agricultural biotech products on the market or in development (cf. http://cera-gmc.org/, see GM crop database therein). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or farnesylated moieties or PEG moieties.

Preferably, the plants treated have not been modified by genetic engineering.

The active components of the mixture can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International. The compositions are prepared in a known manner, such as described by Mollet and

Grubemann, Formulation technology, Wiley VCH, Weinheim, 2001; or Knowles, New developments in crop protection product formulation, Agrow Reports DS243, T&F lnforma, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol.1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin. Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

The agrochemical compositions generally comprise between 0.01 and 95%, preferably between 2 and 90%, and in particular between 10 and 75%, by weight of active components.

The mixtures comprising saflufenacil and ethephon or the compositions thereof are applied in a rate which provides effective desiccation, defoliation and/or ripening. As desiccants, the mixtures comprising saflufenacil and ethephon or the compositions thereof are especially suitable for desiccating the aerial parts of cultivated plants, such as tobacco, potatoes, tomatoes, oil seed rape, sunflowers, soybean, field peas, lentil, dry beans and faba bean, preferably potatoes and soybean. This allows completely mechanical harvesting of these important cultivated plants. Readily controllable defoliation of cultivated plants, in particular cotton, is achieved by using the mixtures according to the invention for promotion of the formation of abscission tissue between fruit or leaf and shoot of the plants. It is also recommendable that mixture can be used as ripener in sugarcane.

The preferred application timing depends on the mixture used and the cultivated plant to be treated, in general after having reached physiological maturity. At physiological maturity the crop has reached maximum possible yield (grain, kernels, etc.), which are no longer growing, merely lose water. It signifies that no additional assimilates are deposited in the developing grain, kernels, etc.

The treatment for defoliation of cotton preferably takes place after the point of physiological maturity has been reached.

The treatment for defoliation of cotton preferably takes place after BBCH growth stage GS 80, more preferably after GS 85, even more preferably after GS 89.

In soybean and dry beans, the treatment for desiccation preferably takes place after the point of physiological maturity has reached meaning after BBCH growth stage GS 89.

In soybean, the treatment for desiccation preferably takes place after growth stage GS 80, more preferably after GS 85, even more preferably after GS 89.

In potato, the treatment for desiccation preferably takes place after the point of physiological maturity has reached.

In potato, the treatment for desiccation preferably takes place when the plants have higher frequency of tuber type II (33 to 45 mm) and/or tuber type III (23 to 55 mm)

In potato, the treatment for desiccation preferably takes place when the plants have average tuber sieve of about 20 to 50 mm.

In potato, the treatment for desiccation preferably takes place after BBCH growth stage GS 80, more preferably after GS 85, even more preferably after GS 89.

In sugarcane the application as a ripener and/or desiccant preferably takes place as pre-harvest application, such as about 30 to 60 days before harvest.

The required application rate of the pure active compounds, i.e. of active component 1) and 2) and/or optionally in combination with a third active component 3) without formulation auxiliary, depends on the crop to be desiccated, defoliated or ripened, on the climatic conditions of the location where the composition is used and on the application method. In general, the application rate is from 0.001 to 3 kg/ha, preferably from 0.005 to 2 kg/ha and in particular from 0.01 to 1 kg/ha, from 0.1 g/ha to 1 kg/ha, from 1 g/ha to 500 g/ha or from 50 g/ha to 1000 g/ha of the amount of all active substances applied.

The preferred application rates of the mixtures and the compositions, depending on the mix-ture used, are for the active component 1) from 50 to 100 g/ha, for the component 2) from 300 to 1000 g/ha and for component 3) in case of cyclanilide from 50 to 150 g/ha and in case of pyraclostrobin from 30 to 150 g/ha, even more preferably 50 to 100 g/ha.

The preferred application rates of the ternary mixtures of component 1) and component 2) and component 3), depending on the mixture used, are from 400 to 1500 g/ha, more preferably from 600 to 1100 g/ha of the amount of all (three) active substances applied.

The preferred application rates of the quartenary mixtures of component 1) and component 2) and component 3) and component 4), depending on the mixture used, are from 450 to 1600 g/ha, more preferably from 600 to 1200 g/ha of the amount of all (three) active substances applied.

The preparations are applied to the plants mainly by spraying, in particular foliar spraying. Application can be carried out by customary spraying techniques using, for example, water as carrier and spray liquid rates of from about 5 to 1000 I/ha (for example from 10 to 400 I/ha). Application of the preparations by the low-volume and the ultra-low-volume method is possible, as is their application in the form of microgranules.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

In the binary mixtures and compositions according to the invention the weight ratio of the component 1) saflufenacil and the component 2) ethephon generally depends from the properties of the active components used, usually it is in the range of from 1:100 to 100:1, regularly in the range of from 1:50 to 50:1, preferably in the range of from 1:20 to 20:1, more preferably in the range of from 1:10 to 10:1, even more preferably in the range of from 1:8 to 8:1 and in particular in the range of from 1:5 to 5:1.

According to further embodiments of the binary mixtures and compositions wherein component 2) is ethephon, the weight ratio of the component 1) and the component 2) usually is in the range of from 1:1 to 1:100, regularly in the range of from 1:1 to 1:50, preferably in the range of from 1:3 to 1:25, more preferably in the range of from 1:4 to 1:20, even more preferably in the range of from 1:5 to 1:10.

According to a further embodiment, in the binary mixtures and compositions according to the invention wherein component 2) is cyclanilide, the weight ratio of the component 1) and the component 2) preferably is in the range of from 1:4 to 4:1, more preferably in the range of from 1:2 to 2:1, even more preferably in the range of from 1:1.5 to 1.5:1 and in particular in the range of about 1:1.

In the ternary mixtures, i.e. compositions according to the invention comprising the component 1) and component 2) and an active compound III (component 3), the weight ratio of component 1) and component 2) is in the range of from 1:1 to 1:100, regularly in the range of from 1:1 to 1:50, preferably in the range of from 1:3 to 1:25, more preferably in the range of from 1:4 to 1:20, and the weight ratio of component 1) and component 3) usually it is in the range of from 1:10 to 10:1, regularly in the range of from 1:4 to 4:1, preferably in the range of from 1:2 to 2:1, more preferably in the range of from 1:1.5 to 1.5:1.

In the quarternary mixture comprise as active components 1) saflufenacil, 2) ethephon, 3) pyraclostrobin and 4) cyclanilide,), the weight ratio of component 1) and component 2) is preferably in the range of from 1:5 to 1:10; the weight ratio of component 1) and component 3) is in the range of from 1.5 to 1.5:1; weight ratio of component 1) and component 4) is in the range of from 1:1.5 to 1.5:1.

Any further active components are, if desired, added in a ratio of from 20:1 to 1:20 to the component 1).

In the mixtures and compositions, the compound ratios are advantageously chosen so as to produce a synergistic effect.

The term “synergstic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Netherl. J. Plant Pathol. 70, 1964).

The components can be used individually or already partially or completely mixed with one another to prepare the composition according to the invention. It is also possible for them to be packaged and used as combination such as a kit of parts.

The defoliating and/or desiccating action of the mixtures and compositions according to the invention can be shown by the tests described below.

### EXAMPLE 1

### Greenhouse Trials for Desiccation in Soybean and Cotton

The trial was established under greenhouse conditions. The objective was to evaluate the dessication activity of saflufenacil solo and in in mixture with cyclanilide and ethephon.

The plants (soybean variety Maxi, cotton Variety Oxford) were sown (Dec. 3, 2012) in pots with 8.5 cm of diameter using standard soil from Limburgerhof, Palatinate, Germany, emerging after 3 days, maintained during the entire growth period at temperatures of about 20 to 24° C., relative humidity of about 65 to 70%, watering in the afternoon or in the morning. Each treatment was composed by 4 replications (one plant per pot).

Foliar treatments were applied 51 days after sowing (Jan. 23, 2013) in a spray cabin with one Flat fan nozzle, using 100 L/ha as application volume. The spray solutions were prepared according to the given concentration of Tables 1 and 2 and contained in addition to the formulations used a surfactant (DASH HC, BASF S.A., Brazil; EC formulation based on methyl esters) at 0,5% (v/v).

Formulations used:

Saflufenacil (70% (w/w), WG formulation; Sharpen® BASF Corporation, USA)

Ethephon (480 g/L, SL formulation)

Cyclanilide, (300 g/kg, WP formulation)

Assessments were made at three days after applicaton in soybean and seven days after application in cotton by evaluating percentage of symptoms of damage to the crop, mainly chlorosis and necrosis. Results applying Colby' s formula are given in Tables 1 and 2 below.

TABLE 1
Soybean

| | Concentration | | Observed | Expected |
|---|---|---|---|---|
| Compound (a.i.) or | (g of a.i. | Mixing | activity | activity |
| mixture tested | per 100 L) | ratio | (%) | (%) |
| untreated control | | n.a. | 0 | n.a. |
| Saflufenacil | 1.4 | n.a. | 15 | n.a. |
| Ethephon | 20 | n.a. | 0 | n.a. |
| Cyclanilide | 1.5 | n.a. | 0 | n.a. |
| Saflufenacil + | 1.4 + 20 | 1:~14.3 | 20 | 15 |
| Ethephon | | | | |
| Saflufenacil + | 1.4 + 1.5 | 1:~1.1 | 20 | 15 |
| Cyclanilide | | | | |

TABLE 2
Cotton

| | Concentration | | Observed | Expected |
|---|---|---|---|---|
| Compound (a.i.) or | (g of a.i. | Mixing | activity | activity |
| mixture tested | per 100 L) | ratio | (%) | (%) |
| untreated control | | n.a. | 0 | n.a. |
| Saflufenacil | 1.4 | n.a. | 18.8 | n.a. |
| Ethephon | 20 | n.a. | 0 | n.a. |
| Cyclanilide | 1.5 | n.a. | 0 | n.a. |
| Saflufenacil + | 1.4 + 20 | 1:~14.3 | 20 | 18.8 |
| Ethephon | | | | |
| Saflufenacil + | 1.4 + 1.5 | 1:~1.1 | 22.5 | 18.8 |
| Cyclanilide | | | | |

Addition of ethephon and cyclanilide to saflufenacil resulted in better desiccation performance.

### EXAMPLE 2

### Field Trial for Defoliation in Cotton

The field experiments on cotton were carried out at the Grupo, Torre, located in Pedra Preta, Mato grosso state, Brazil, using big plots with 60 m². The cotton variety Fiber Max 966 LL was sown (May 30, 2012) using 14 seeds by linear meter; row width 0.9 m.

Foliar treatments were applied in were applied with a knapsack sprayer with five Flat fan spray nozzles (nozzle spacing: 0.5 m), using 150 L/ha as application volume.

The spray solutions were prepared according to the given concentration in Table 3 and contained in addition to the formulations used a surfactant (DASH HC, BASF S.A., Brazil; EC formulation based on methyl esters) at 0,5% (v/v).

Formulations used:

Saflufenacil (70% (w/w), WG formulation; Sharpen® BASF Corporation, USA)

Ethephon (480 g/L, SL formulation)

Pyraclostrobin (250 g/L, EC formulation; Comet® EC, BASF SE, Germany).

Assessments were made at five days after applicaton evaluating percentage of defoliation. Results are given in Tables 1 and 2 below.

TABLE 3

| Compound | | | | Activity |
|---|---|---|---|---|
| (a.i.) or | Concentration | | Observed | increase |
| mixture tested | (g a.i. per ha) | Mixing ratio | activity (%) | (%) |
| Saflufenacil + | 49 + 216 | 1 + 4.4 | 50 | n.a. |
| Etephon | | | | |
| Saflufenacil + | 50 + 216 + 75 | 1 + 4.4 + 1.5 | 85 | 70 |
| Etephon + | | | | |
| Pyraclostrobin | | | | |

As can be seen in the Table 3, adding pyraclostrobin to the mixture of saflufenacil and ethephon resulted in improved defoliation (70% increased over the binary mixture).

We claim:

1. A mixture comprising, as active components:
1) saflufenacil and
2) ethephon or cyclanilide.

2. The mixture according to claim 1, wherein component 1) and component 2) are present in a synergistically effective amount.

3. The mixture according to claim 2, wherein component 2) is ethephon.

4. The mixture according to claim 2, wherein component 2) is cyclanilide.

5. The mixture according to claim 3, wherein component 1) and component 2) are present in a total weight ratio of from 1:1 to 1:50.

6. The mixture according to claim 5, wherein component 1) and component 2) are present in a total weight ratio of from 1:4 to 1:20.

7. The mixture according to claim 4, wherein component 1) and component 2) are present in a total weight ratio of from 1:20 to 20:1.

8. The mixture according to claim 7, wherein component 1) and component 2) are present in a total weight ratio of from 1:2 to 2:1.

9. The mixture according to claim 1, consisting of, as active components, saflufenacil and ethephon.

10. The mixture according to claim 1, consisting of, as active components, saflufenacil and cyclanilide.

11. The mixture according to claim 3 comprising at least one further active compound select-ed from the class of bio regulators consisting of:
pyraclostrobin, abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole.

12. The mixture according to claim 11, wherein the further active compound is selected from cyclanilide and pyraclostrobin.

13. An agrochemical composition, comprising an auxiliary and a mixture as defined in claim 1.

14. A method for defoliation, desiccation or ripening of cultivated plants treating the plants to be defoliated, desiccated or ripened, with a mixture as claim 1.

15. The method according to claim 14, wherein the cultivated plants are selected from cotton, tobacco, potatoes, tomatoes, oil seed rape, rice, sunflowers, soybean, field peas, lentil, sugar cane, drybeans and faba bean.

16. The method for defoliation according to claim 14, wherein the cultivated plant is cotton.

17. The method for ripening according to claim 14, wherein the cultivated plant is sugar cane.

18. The method of claim 14, wherein component 1) and component 2) are present in a synergistically effective amount.

19. The method of claim 18, wherein component 2) is ethephon.

20. The method of claim 18, wherein component 2) is cyclanilide.

21. The method of claim 19, wherein component 1) and component 2) are present in a total weight ratio of from 1:1 to 1:50.

22. The method of claim 21, wherein component 1) and component 2) are present in a total weight ratio of from 1:4 to 1:20.

23. The method of claim 20, wherein component 1) and component 2) are present in a total weight ratio of from 1:20 to 20:1.

24. The method of claim 23, wherein component 1) and component 2) are present in a total weight ratio of from 1:2 to 2:1.
